(19) United States
(12) Patent Application Publication
(10) Pub. No.: US 2025/0110229 A1
(43) Pub. Date: Apr. 3, 2025

(54) COMMUNICATION AND SENSING SYSTEM

(71) Applicant: Cypress Semiconductor Corporation, San Jose, CA (US)

(72) Inventors: Igor Kolych, Lviv (UA); Claudio Rey, Chandler, AZ (US)

(73) Assignee: Cypress Semiconductor Corporation, San Jose, CA (US)

(21) Appl. No.: 18/478,860

(22) Filed: Sep. 29, 2023

(51) Int. Cl. G01S 13/08; G01S 13/931

(52) U.S. Cl. CPC G01S 13/08; G01S 13/931; G01S 2013/9329

(57) ABSTRACT

Methods and systems for communication and sensing systems. The disclosed method includes, among other things, transmitting, from a first wireless device of a plurality of wireless devices, a sensing signal, receiving, by a second wireless device of the plurality of wireless devices, a set of signals derived from the sensing signal, and determining, based on characteristics of the set of signals, a first distance to each object located near the first wireless device and the second wireless device.

### TECHNICAL FIELD

Aspects and implementations of the present disclosure relate to communication and sensing systems.

### BACKGROUND

Sensing system utilizing radar sensing plays a crucial role in automotive applications for recognizing the environment and detecting other vehicles on the road. It enables various driver-assistance features, such as object detection, adaptive cruise control (ACC), autonomous emergency braking (AEB), blind spot detection (BSD), cross-traffic alert (CTA), and parking assistance to enhance overall safety.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A illustrates an example communication and sensing system, in accordance with implementations of the present disclosure.

FIG. 1B illustrates an example communication and sensing system, in accordance with implementations of the present disclosure.

FIG. 2A is an exemplary illustration of the system using the various wireless devices for blind spot detection on an automotive vehicle, in accordance with implementations of the present disclosure.

FIG. 2B is a sequence diagram illustrating a method of performing blind spot detection using bistatic and/or monostatic radars, in accordance with implementations of the present disclosure.

FIG. 3A is an exemplary illustration of the system using wireless devices for keyless entry, in accordance with implementations of the present disclosure.

FIG. 3B is a sequence diagram illustrating a method of performing keyless entry using wireless devices, in accordance with implementations of the present disclosure.

FIG. 4 depicts a flow diagram of an example method for switching between blind spot detection and keyless entry, in accordance with implementations of the present disclosure.

FIG. 5 depicts a flow diagram of an example method for blind spot detection, in accordance with implementations of the present disclosure.

FIG. 6 depicts a flow diagram of an example method for switching between modes of the communication and sensing system, in accordance with implementations of the present disclosure.

FIG. 7 depicts a flow diagram of an example method for object detection, in accordance with implementations of the present disclosure.

FIG. 8 is a block diagram illustrating an exemplary computer system, in accordance with implementations of the present disclosure.

### DETAILED DESCRIPTION

Aspects of the present disclosure relate to communication and sensing systems. Radar systems (e.g., radars) typically include a transmitter, a receiver, and an antenna. The transmitter of the radar generates and sends out radio waves, while the antenna of the radar focuses and directs these waves toward the target area. When the radio waves hit an object, they are reflected back towards the antenna of the radar and received by the receiver of the radar. The receiver of the radar then processes the received signals to extract useful information about the detected objects.

Dedicated radars may be used as a wireless sensing device to enable various driver-assistance features. Dedicated radars are typically designed and optimized for specific applications or functions. They are tailored to meet the specific requirements of their intended use, such as range, resolution, and environmental conditions. While dedicated radars offer optimized performance, accuracy, and reliability within their designated application, they are limited to their intended purpose. Accordingly, each specific application or function requires a separate radar which can be rather costly.

Wireless devices are developed for communication and may perform localization and sensing. Such wireless devices may be ultra-wide band (UWB) devices, BT/BLE, or WLAN. Communication capability is necessary for localization because of security requirements. In some embodiments, wireless device (e.g. UWB) may operate as a monostatic radar. If the location of two wireless devices are fixed, they can operate as bistatic radars. Such multipurpose solutions have lower performance compared to dedicated radars and may not provide complete information about the environment. Additionally, the cost of the sensing solution may be reduced. Monostatic radars may be used as a wireless sensing device to reduce the cost associated with dedicated radars. Monostatic radars are typically designed and optimized to be used for a wide range of applications. Monostatic radars require fewer hardware components and are often simpler and more compact compared to dedicated radar systems. In particular, monostatic radars collocate (e.g., share the same physical location) the transmitter and the receiver, and therefore share a single antenna for both transmitting and receiving signals. While monostatic radars are compact and utilized for a wide range of applications, they suffer from self-interference, limited resolution, clutter, jamming, and other drawbacks that limit its capabilities for sensing or detection.

Bistatic radars may be used for radar sensing to obtain more complete and accurate information than monostatic radars. Bistatic radars, unlike monostatic radars, separate the transmitter and receiver, and therefore the transmitter and receiver utilize separate antennas for transmitting and receiving signals. Due to the separation of the receiver from the transmitter, bistatic radars provide much-needed improvement over the performance of monostatic radars. Further, bistatic radars may measure angles of arrival (e.g., incident direction) to provide valuable insights into the position, trajectory, and orientation of detected targets (e.g., better localization and tracking of objects). However, bistatic radars suffer from synchronization issues between the transmitter and receiver.

Wireless local area networks (WLAN), such as Wi-Fi®, may be used as a wireless sensing device by exploiting the reflections and interactions of WLAN signals with objects in the environment to infer their presence, location, and movement. Unlike bistatic radars, WLAN radars (or Wi-Fi radars) may employ a dedicated reference channel for synchronization. However, the accuracy and range of WLAN radars may be affected by factors such as signal interference, multipath effects, and the specific environment in which it is deployed. Accordingly, WLAN radars are typically placed indoors and not on the outside of an automobile as a wireless sensing device.

Aspects and embodiments of the present disclosure address these limitations of the existing technology by providing a communication and sensing system (e.g., system) that can utilize a plurality of wireless devices dispersed around a vehicle for multiple applications, such as blind spot detection (BSD) and keyless entry (KLE). In particular, the system may switch between the various applications. During BSD, the system may cause a wireless device of the plurality of wireless devices to transmit a signal that is received by one or more of the plurality of wireless devices, including the wireless device that transmitted the signal. The one or more of the plurality of wireless devices may receive the transmitted signal directly from the wireless device that transmitted the signal and the transmitted signal is reflected off an object (e.g., reflected signal). Each of the one or more of the plurality of wireless devices may utilize the transmitted signal directly received from the wireless device that transmitted the signal as a reference signal. Each of the one or more of the plurality of wireless devices may calculate, based on the reference signal, an estimated distance. The estimated distance from each of the one or more of the plurality of wireless devices is provided to the system to perform object detection, ranging (localization), and/or tracking. The information from object detection, localization, and/or tracking is utilized to alert a driver to an object.

Similarly, during KLE, the system may cause a wireless device of the plurality of wireless devices to transmit a signal that is received by a key fob. The key fob transmits, in response to receiving the signal from the wireless device, a signal to one of the plurality of wireless devices. The wireless device that receives the signal from the key fob calculates an estimated distance. The estimated distance from the wireless device a provided to the system to perform localization, and/or tracking. The information from object detection, localization, and/or tracking is utilized to provide a user control of a vehicle.

Aspects of the present disclosure overcome these deficiencies by utilizing wireless devices for multiple purposes, thereby reducing the overall cost of the system. Additionally, increasing angular resolution, thereby eliminating ambiguity and improving spatial details and accuracy.

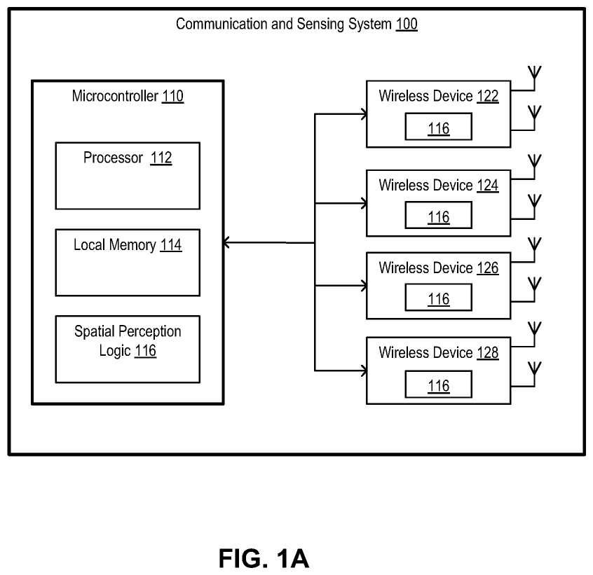

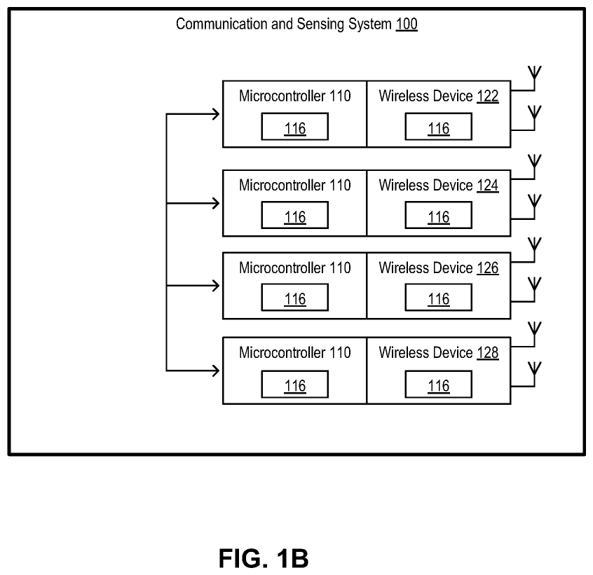

FIG. 1A illustrates an example of communication and sensing system architecture 100, in accordance with implementations of the present disclosure. Communication and sensing system architecture 100 (also referred to as “system” herein) includes a microcontroller 110 and multiple wireless devices 122-128 that are communicatively coupled to each other. In one embodiment, the system 100 is integrated within a vehicle, airplane, or other more extensive operation device.

Each of the wireless devices 122-128 includes a radio and digital processing circuitry (e.g., digital part) that are communicatively coupled to each other via a wired communication interface, such as, a controller area network (CAN). In some embodiments, the wireless device may be communicatively coupled via a wireless channel. In some embodiments, the wireless device (e.g., wireless devices 122-128) may use communication signals for sensing applications. The wireless device may be configured to utilize signals with large bandwidth, spanning several hundred megahertz, to achieve high-range resolution and accuracy. The wireless device may operate in either a full-duplex mode or a half-duplex mode. Full-duplex operation transmits and receives signals simultaneously over the same frequency band without needing to switch between transmitting and receiving. Half-duplex operation either transmits or receives signals at a given time, but not both simultaneously, by switching between transmitting and receiving based on a predetermined schedule or protocol. Depending on the embodiment, the wireless devices 122-128 may be an ultra-wide band (UWB) device, any other radar module, a wireless local area network (WLAN) module, or a wireless personal area network (WPAN) module (e.g., BT/BLE devices).

A radio includes a set of antennas (e.g., transmitting antenna and receiving antenna) coupled to a radio frequency (RF) circuitry to transmit and receive radio frequency signals. In some embodiments, a single antenna with Transmit/Receive (T/R) switch may be used to transmit and receive signals. To perform sensing (e.g., BSD), the transmitting antenna emits radio frequency signals (e.g., transmitted signals) through space to encounter objects in their path. The transmitted signals may encounter objects, such as vehicles, buildings, or other obstacles. Thus a portion of the transmitted signals may reflect back toward the receiving antenna (e.g., received signals). The receiving antenna captures the reflected signals, which carry information about the object's properties, including their distance, velocity, and sometimes even their shape or size. The received signals are processed by the RF circuitry, which includes components like amplifiers, filters, mixers, and detectors to process and analyze the received signals to extract relevant information as a wireless sensing device.

To perform localization (e.g., KLE), the transmitter of the first wireless device emits a signal that is received by the receiver of the second wireless device. Then the transmitter of the second wireless device emits a signal to the first wireless device. The traveling time of the signals carries information about the distance between two wireless devices.

Digital digital signal processing (DSP) in the receiver does among other things range estimation using various techniques and algorithms to analyze and extract information from the received signals. The DSP may also do filtering, modulation/demodulation, noise reduction, equalization, synchronization, and various other typical operations. Range estimation can include estimating the range or distance to the target object based on the properties of the received signals by measuring the time delay and/or phase shift between the transmitted and received signals and converting it into a range value by accounting for the speed of propagation.

Microcontroller 110 includes a processor 112 and local memory 114. Processor 112 may be capable of executing the computing tasks. Processor 112 may be a single-core processor that is capable of executing one instruction at a time or may be a multi-core processor that simultaneously executes multiple instructions. The instructions may encode arithmetic, logical, or I/O operations. In one example, the processor may be implemented as a single integrated circuit, two or more integrated circuits, or may be a component of a multi-chip module. Processor 112 may also be referred to as a central processing unit (“CPU”).

The local memory 114 may be any data storage device that is capable of storing data and may include volatile or non-volatile data storage. Volatile data storage (e.g., non-persistent storage) may store data for any duration of time but may lose the data after a power cycle or loss of power. Non-volatile data storage (e.g., persistent storage) may store data for any duration of time and may retain the data beyond a power cycle or loss of power. In one example, local memory 114 may be physical memory and may include volatile memory devices (e.g., random access memory (RAM)), non-volatile memory devices (e.g., flash memory, NVRAM), and/or other types of memory devices. In another example, local memory 114 may include one or more mass storage devices, such as hard drives, solid-state drives (SSD)), other data storage devices, or a combination thereof. In a further example, local memory 114 may include a combination of one or more memory devices, one or more mass storage devices, other data storage devices, or a combination thereof, which may or may not be arranged in a cache hierarchy with multiple levels.

Each of the wireless devices 122-128 and/or microcontroller 110 may include a spatial perception logic 116 that obtains estimated distances based on a reference signal and/or one or more reflected signals from one or more wireless devices for distance-based analysis. such as object detection, localization and/or tracking. Additionally, managing switching between multiple applications of the wireless devices. In some embodiments, a wireless device may be an anchor device playing a central role. The anchor device may coordinate other wireless devices. Depending on the embodiment, the spatial perception logic 116 of microcontroller 110 may be configured to aggregate data from each of the wireless devices 122-128 and provide commands to other components (e.g., locks, LEDs, etc.).

Spatial perception logic 116 may utilize wireless device(s) 122-128 for various applications, such as blind spot detection (BSD) and keyless entry (KLE). BSD assists drivers in identifying vehicles or objects that may be present in their blind spots, which are areas that are difficult to see using the side mirrors or rearview mirrors alone. KLE allows users to lock, unlock, and access their vehicle without using a traditional physical key by utilizing wireless technology to communicate between the vehicle and a key fob or a mobile device.

During BSD, spatial perception logic 116 may alternate selecting a wireless device from the wireless device 122-128 (e.g., selected wireless device). Spatial perception logic 116 may initiate transmission, from the selected wireless device, a radio frequency (RF) signal (e.g., transmitted signal). Spatial perception logic 116 may operate the selected wireless device in half-duplex mode. Accordingly, the selected wireless device is switched to transmission to transmit the RF signal, and subsequently switched to reception to receive RF signals. In some embodiments, the transmitted signal may be reflected off an object (e.g., an automotive, a building, a person, etc.) (e.g., reflected signal). The reflected signal may be received by the selected modules and/or the remaining wireless devices of the wireless devices 122-128 (e.g., non-selected wireless devices). In some embodiments, one or more of the non-selected wireless devices may directly receive the transmitted signal. The directly received transmitted signal may be utilized as a reference signal. Each of the wireless devices 122-128 may calculate an estimated distance based on each of the received signals (e.g., reference signal and/or one or more reflected signals) received by a respective wireless device (e.g., receiving wireless device). In some embodiments, a receiving wireless device calculates the estimated distance for the received signals that satisfy a signal threshold criterion. The signal threshold criterion is satisfied if the reflected signal and the reference signal exceed a predetermined threshold value indicating that the reflected signal is a sufficiently large signal. In some embodiments, the reflected signal is preprocessed using one or more algorithms to extract an individual path of each reflection. Thus, a predetermined threshold value may be applied to the individual path of each reflection. The receiving wireless device may calculate a reception time of each of the received signals. In particular, each received signal is sampled with high speed analog-to-digital converter. The sampled received signal can be correlated with an expected shape of a single reflection or any suitable combination of the received signal and reference signal. Accordingly, the reception time of individual received path may be defined by the correlation peaks. The receiving wireless device calculates, based on the reception time of the received signals, the estimated distance to the object. In particular, receiving wireless device obtains, for each of the one or more reflected signals, a difference between the reference signal and a respective reflected signal of the one or more reflected signals. Each difference associated with a reflected signal of the one or more reflected signals is converted to an estimated distance to the object. For example, the receiving wireless device may multiply the speed of the propagation of the signal, which is usually the speed of light, with the reception time divided by two which represents the round trip time of the signal (e.g., one-way travel time) to convert the difference associated with the reflected signal to an estimated distance.

The receiving wireless device may provide the estimated distance to the spatial perception logic 116 to perform distance-based analysis, such as object detection, localization and/or tracking. In some embodiments, the spatial perception logic 116 may receive multiple estimated distances from one or more receiving wireless devices. In some embodiments, in addition to the multiple estimated distances, the spatial perception logic 116 may receive information, such as ranging information, velocity information, angular information, etc., from other sources, such as ultrasonic sensors, laser modules, ultrasonic sensors, antennas, continuous wave devices, etc. Object detection uses estimated distances (and information from other sources) to detect the presence of objects within a sensing range by comparing the measured distances to a predetermined threshold to determine whether an object is present. Localization combines estimated distances from multiple wireless devices and/or information from other sources to accurately estimate the position and/or coordinates of the object. Tracking continuously obtains and updates the estimated distances (and information from other sources) to tracked objects to calculate the object's velocities, trajectories, and movement patterns.

During KLE, spatial perception logic 116, similar to BSD, may alternate selecting a wireless device from the wireless device 122-128 (e.g., selected wireless device). Spatial perception logic 116 may initiate transmission, from the selected wireless device, a radio frequency (RF) signal (e.g., transmitted signal of the selected wireless device). Spatial perception logic 116 may operate the selected wireless device in half-duplex mode. If the key fob is not within range of the selected wireless device, the key fob does not receive the transmitted signal of the selected wireless device. The spatial perception logic 116 may wait a predetermined time period to receive a transmitted signal from the key fob. If the predetermined time period has elapsed, the spatial perception logic 116 selects another wireless device from the wireless device 122-128 to transmit an RF signal.

If the key fob is within range of the selected wireless device, the key fob may receive the transmitted signal of the selected wireless device. The key fob, in response to receiving the transmitted signal of the selected wireless device, transmits an RF signal (e.g., the transmitted signal of the key fob). The transmitted signal of the key fob may be received by the selected modules and/or the remaining wireless devices of the wireless devices 122-128 (e.g., non-selected wireless devices). In response to the wireless device(s) receiving the transmitted signal of the key fob (e.g., the receiving wireless device) communication may be established and security confirmed. Localization may be initiated thereby requiring the exchange of multiple signals, and in some instances sets of packets that consist of wide-band signals.

The spatial perception logic 116 may be further configured to switch between the applications (e.g., BSD and KLE). The spatial perception logic 116 may include a wake-up timer for each of the applications (e.g., timers). Timers may refer to a BSD wake-up timer and a KLE wake-up timer. After performing actions of the applications, spatial perception logic 116 starts the timers (e.g., both BSD timer and KLE timer). After starting the timers, spatial perception logic 116 checks to see if the timers have lapsed. Spatial perception logic 116 determines whether one of the applications has started. Based on neither of the applications being started, spatial perception logic 116 may check to see if the timers have lapsed. Based on whether one of the applications has started, spatial perception logic 116 performs actions associated with the application (e.g., BSD or KLE). After the completion of the actions associated with the application is performed by the spatial perception logic 116, spatial perception logic 116 repeats the process of starting the timer, checking the timer, determining a started application, etc.

FIG. 1B illustrates another example of communication and sensing system architecture 100, in accordance with implementations of the present disclosure. Similar to FIG. 1A, communication and sensing system architecture 100 (also referred to as “system” herein) includes multiple wireless devices 122-128 that are communicatively coupled to each other. However, each of the multiple wireless devices 122-128 includes an integrated microcontroller 110. Thus, each of the wireless devices 122-128 via the integrated microcontroller 110, similar to FIG. 1A, may obtain estimated distances based on a reference signal and/or one or more reflected signals from one or more wireless devices for distance-based analysis, such as object detection, localization and/or tracking. Additionally, managing switching between multiple applications of the wireless devices. In some embodiments, a wireless device may be an anchor device playing a central role. The anchor device may coordinate other wireless devices. Depending on the embodiment, the spatial perception logic 116 of the anchor device may be configured to aggregate data from the remaining wireless devices and provide commands to other components (e.g., locks, LEDs, etc.).

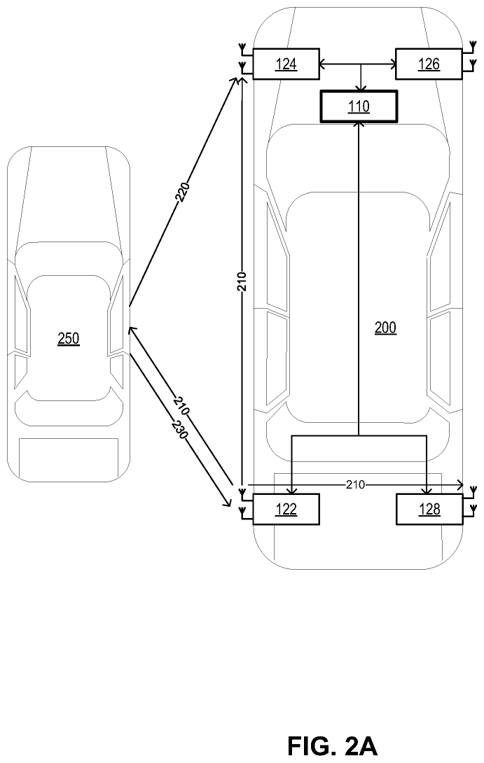

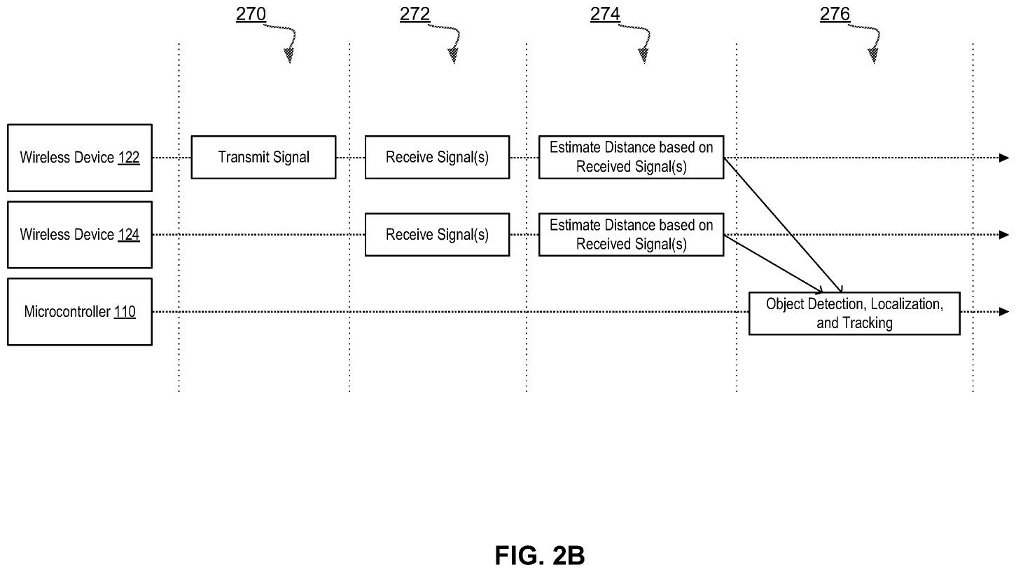

FIG. 2A is an exemplary illustration of the system using the various wireless devices for blind spot detection on an automotive vehicle, in accordance with implementations of the present disclosure. Spatial perception logic 116 is located within vehicle 200. Each of the wireless devices 122-128 is dispersed along the perimeter of vehicle 200. The microcontroller 110 and the wireless devices 122-128 are communicatively coupled. Accordingly, the microcontroller 110 and the wireless devices 122-128 may communicate over wireless channels and/or wired connections. As previously described, the spatial perception logic of the wireless devices performs the operations and the results can be aggregated by the wireless device or the spatial perception logic of the microcontroller. The microcontroller, based on the aggregated results, may control other components of vehicle 200, such as locks and LEDs in mirrors.

With reference to FIG. 2B, a sequence diagram illustrating a method of performing blind spot detection using the various wireless devices, spatial perception logic 116, initiates wireless device 122. At moment 270, wireless device 122 switches to transmission and transmits signal 210. After transmission of signal 210, the wireless device 122 switches to reception to receive signals. At moment 272, signal 210 may be directly received by wireless devices of vehicle 200 (e.g., wireless device 124 and/or wireless device 128). Signal 210 may also contact an object (e.g., vehicle 250) and reflect one or more signals back (e.g., reflected signals 220 and 230) to the wireless devices of vehicle 200. In some embodiments, wireless device 122 may receive reflected signal 230 and/or wireless device 124 may receive reflected signal 220. At moment 274, as previously described, wireless device 122 may obtain an estimated distance based on signal 210 and reflected signal 230 and wireless device 124 may obtain an estimated distance based on signal 210 and reflected signal 220.

Wireless device 122 and 124 may provide the one or more estimated distances to microcontroller 110 or one of wireless device 122 or 124. At moment 276, as previously described, distance-based analysis, such as, such as object detection, localization, and/or tracking may be performed using the one or more estimated distances. In some embodiments, additional ranging information, velocity information, and/or angular information may be provided, by other sensors and/or radars, to the microcontroller 110 to assist with the distance-based analysis. Accordingly, microcontroller 110 may provide vehicle 200 with information regarding the presence, position, coordinate, velocity, trajectory, and/or movement of vehicle 250.

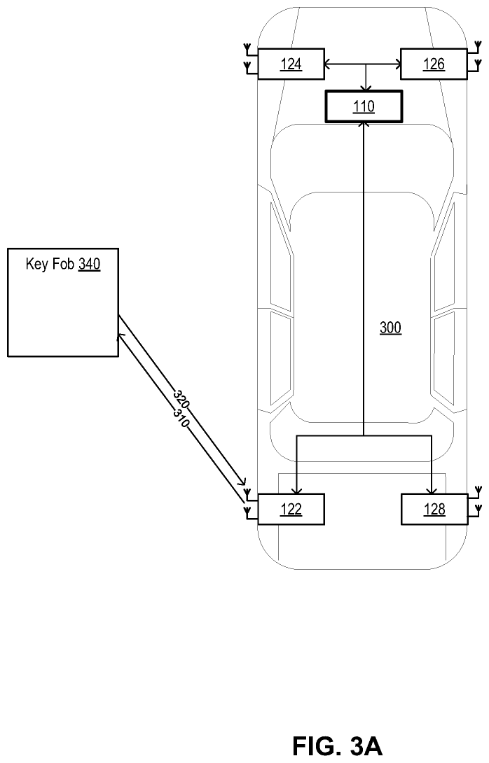

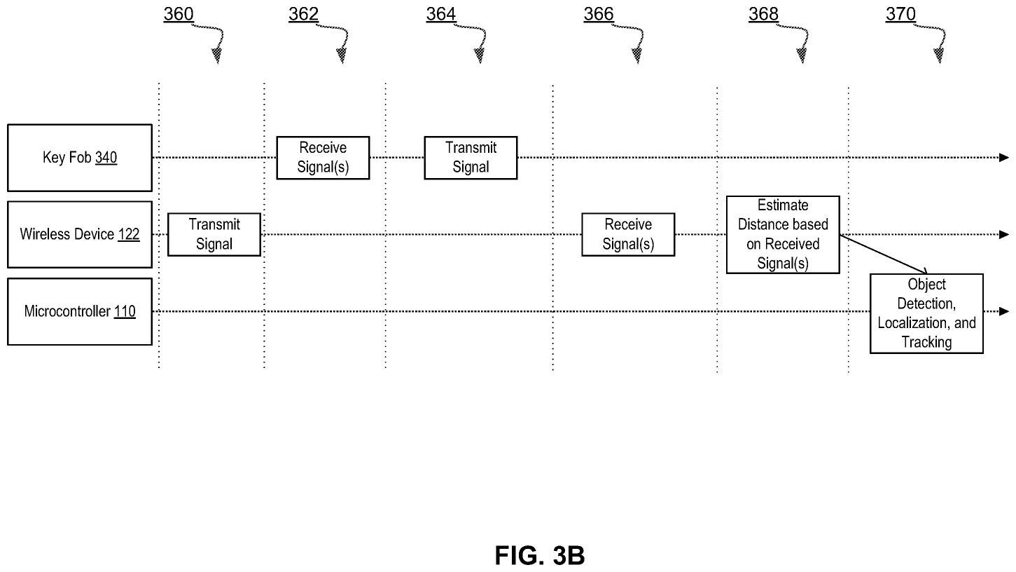

FIG. 3A is an exemplary illustration of the system using the various wireless devices for keyless entry (KLE) on an automotive vehicle, in accordance with implementations of the present disclosure. Spatial perception logic 116 is located within vehicle 300. Each of the wireless devices 122-128 is dispersed along the perimeter of vehicle 300. The microcontroller 110 and the wireless devices 122-128 are communicatively coupled.

With reference to FIG. 3B, a sequence diagram illustrating a method of performing keyless entry using the various wireless devices, microcontroller 110, more specifically spatial perception logic 116, initiates wireless device 122. At moment 360, microcontroller 110 switches wireless device 122 to transmission and transmits signal 310. After transmission of signal 310, the microcontroller 110 switches wireless device 122 to reception to receive signals. At moment 362, a key fob 340 nearby receives signal 310. At moment 364, in response to key fob 340 receiving signal 310, key fob 340 transmits signal 320. At moment 366, wireless device 122 receives signal 320. As previously described, wireless device 122 obtains an estimated distance based on signal 320. Wireless device 122 provides the estimated distance to microcontroller 110. As previously described, microcontroller 110 performs, using the estimated distances, distance-based analysis, such as, such as object detection, localization, and/or tracking. In some embodiments, additional ranging information, velocity information, and/or angular information may be provided, by other sensors and/or radars, to the microcontroller 110 to assist with the distance-based analysis. Accordingly, microcontroller 110 may provide a user control of vehicle 300 based on the presence of key fob 340.

In some embodiments, spatial perception logic 116 may confirm the presence of key fob 340 within vehicle 300. In particular, while wireless device 122 is performing keyless entry, another wireless device, such as wireless device 124 may perform BSD for localization of the key fob 340. In some embodiments, communication signal 310 of wireless device 122 can be used by wireless device 124 to perform BSD.

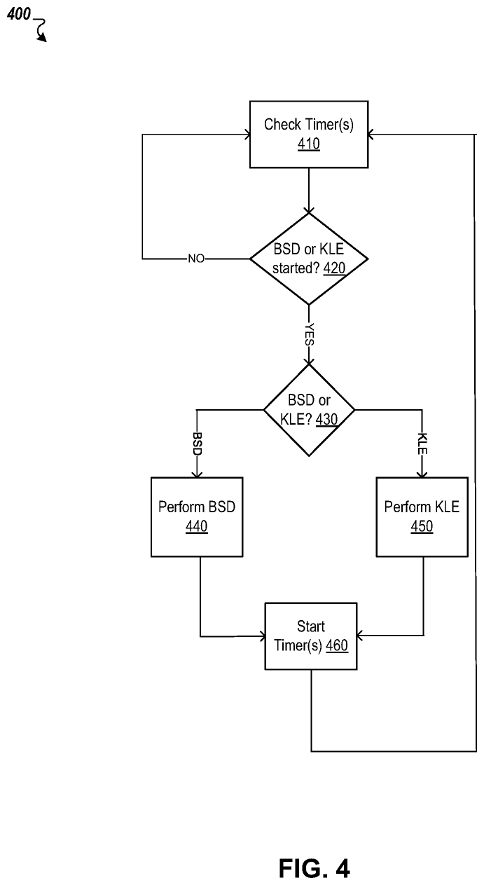

FIG. 4 depicts a flow diagram of an example method for switching between blind spot detection and keyless entry for each wireless device, in accordance with implementations of the present disclosure. In particular, each wireless device may use the same or different applications (BSD and/or KLE). Accordingly, each device may play a central role or a peripheral role (e.g., managed and/or coordinated by the wireless device playing a central role). Thus, each wireless device may be in different states during execution of a particular role. Method 400 can be performed by processing logic that can include hardware (circuitry, dedicated logic, etc.), software (e.g., instructions run on a processing device), or a combination thereof. In one implementation, some, or all of the operations of method 400 can be performed by one or more components of system 100 of FIG. 1A and/or FIG. 1B. In some embodiments, some, or all of the operations of method 400 can be performed by spatial perception logic 116, as described above.

At block 410, the processing logic checks the timers and proceeds to block 420. As previously described, checking the timer refers to checking to see if a timer (e.g., BSD wake-up timer or KLE wake-up timer) has lapsed. In some embodiments, the wireless device is in idle/sleep mode. The wireless device may periodically and/or continuously listen for communication via a wireless and/or wired channel based on the timers.

At block 420, the processing logic determines whether BSD or KLE has been started. In response to determining that BSD or KLE has been started, the processing logic proceeds to block 430. In some embodiments, the processing logic may receive a command to switch to an application (e.g., BSD). In some instances, a set of instructions, a start time of the application, and a corresponding timer are started. Once the timer expires, the application is started. Otherwise, the processing logic proceeds to block 410.

At block 430, in response to determining that BSD was started, the processing logic proceeds to 440. Otherwise, the processing logic proceeds to 450. At block 440, the processing logic performs actions associated with BSD. As previously described, the processing logic periodically selects a wireless device of the plurality of wireless devices to transmit an RF signal. The RF signal may reflect off any object. Each of the plurality of wireless devices that receives one or more signals (e.g., receiving wireless devices) determines a reception time for each of the received signals. The one or more signals may be transmitted directly from the selected wireless device (e.g., reference signal) and/or one or more reflected signals. Each of the receiving wireless devices obtains a difference between the reference signal and each of the one or more reflected signals. The receiving wireless devices converts each of the differences calculated to an estimated distance. Each of the estimated distances is provided to the spatial perception logic 116 for distance-based analysis.

As a response to the completion of performing the actions associated with BSD, the processing logic continues in block 460. The outcome of performing the actions associated with BSD may include detecting an object in the environment and/or receiving an indication to go to sleep.

At block 450, the processing logic performs actions associated with KLE. As previously described, the processing logic periodically transmits a signal from a selected wireless device. The signal may be received by a key fob. The key fob transmits a signal which may be received by the selected wireless device. The selected wireless devices calculate estimated distances based on the received signal from the key fob. The estimated distance is provided to the spatial perception logic 116 for distance-based analysis. In response to the completion of performing the actions associated with KLE. In response to completion of performing the actions associated with BSD, continues in block 460. The outcome of performing the actions associated with KLE may include localizing the key fob or determining that the key fob is absent.

At block 460, the processing logic starts timers (e.g., wake-up timers). As previously described, timers may be BSD wake-up timers and KLE wake-up timers. In particular, once the application is completed the timer may be started and listening may be initiated.

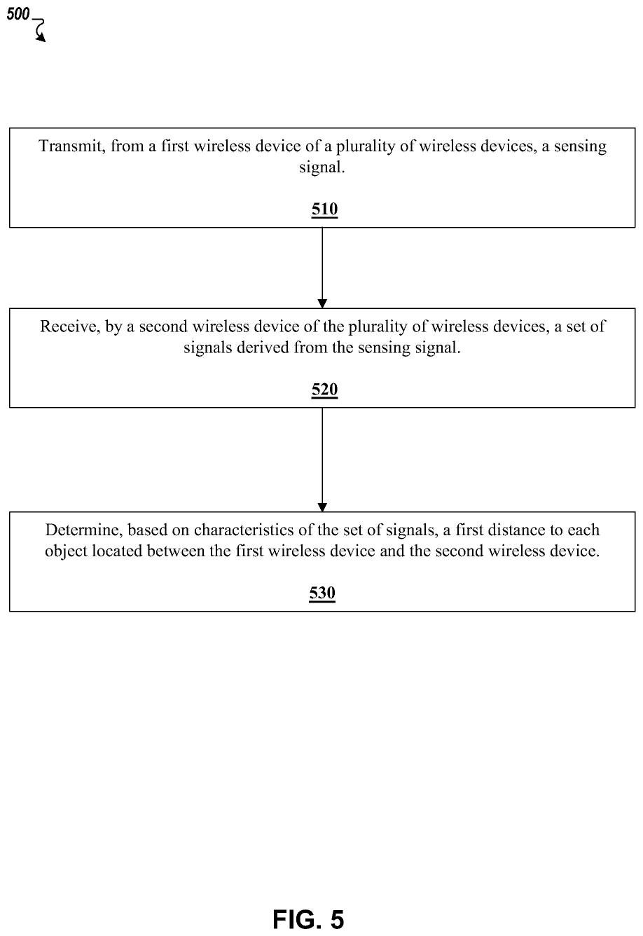

FIG. 5 depicts a flow diagram of an example method 500 for blind spot detection, in accordance with implementations of the present disclosure. Method 500 can be performed by processing logic that can include hardware (circuitry, dedicated logic, etc.), software (e.g., instructions run on a processing device), or a combination thereof. In one implementation, some, or all of the operations of method 500 can be performed by one or more components of system 100 of FIG. 1. In some embodiments, some, or all of the operations of method 500 can be performed by spatial perception logic 116, as described above.

At block 510, the processing logic transmits from a first wireless device of a plurality of wireless devices a sensing signal (e.g., RF signal). Each of the wireless devices may be a wireless local area network (WLAN) module, or a wireless personal area network (WPAN) module.

At block 520, the processing logic receives, by a second wireless device of the plurality of wireless devices, a set of signals derived from the sensing signal. The set of signals may include a non-reflected sensing signal (e.g., received directly from the first wireless device) and one or more reflected sensing signals. Each reflected sensing signal may be a sensing signal that reflected off an object located near the first wireless device and the second wireless device that exceeds a predetermined signal threshold.

At block 530, the processing logic determines, based on characteristics of the set of signals, a first distance to each object located near the first wireless device and the second wireless device. In particular, to determine the first distance to each object located near the first wireless device and the second wireless device, the processing logic determines a reception time for each signal of the set of signals, calculates, for each reflected sensing signal of the set of signals, a difference between the reception time of a respective reflected sensing signal and the reception time of a non-reflected sensing signal of the set of signals. Each reflected sensing signal corresponds to an object located near the first wireless device and the second wireless device that reflected the sensing signal. Each of the differences associated with a reflected sensing signal of the set of signals is then converted to the first distance.

Depending on the embodiment, the processing logic switches the first wireless device from transmitting to receiving. The first wireless device may receive a set of reflected sensing signals to determine, based on characteristics of the set of reflected sensing signals, a second distance to each object located near the first wireless device that reflected the sensing signal. Accordingly, the processing logic obtains, based on the first distance and the second distance, a final distance for each object located near the first wireless device and near the first wireless device and the second wireless device.

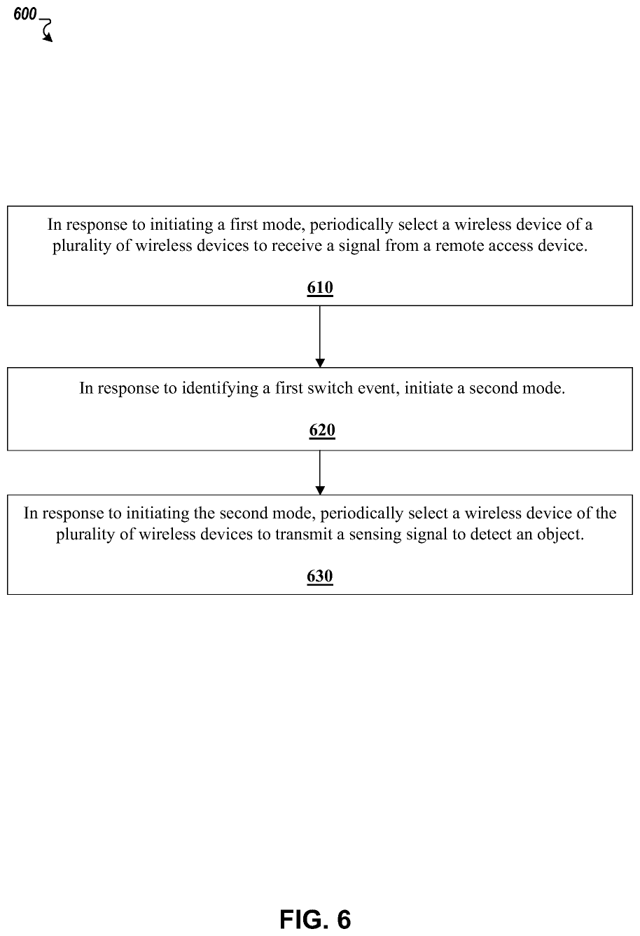

FIG. 6 depicts a flow diagram of an example method 600 for switching between modes of the communication and sensing system, in accordance with implementations of the present disclosure. Method 600 can be performed by processing logic that can include hardware (circuitry, dedicated logic, etc.), software (e.g., instructions run on a processing device), or a combination thereof. In one implementation, some, or all of the operations of method 600 can be performed by one or more components of system 100 of FIG. 1. In some embodiments, some, or all of the operations of method 600 can be performed by spatial perception logic 116, as described above.

At block 610, in response to initiating a first mode, the processing logic periodically selects a wireless device of a plurality of wireless devices to receive a signal from a remote access device. In response to receiving the signal from the remote access device by a selected wireless device of the plurality of wireless devices, the processing logic transmits, from the selected wireless device, a signal indicating that the remote access device is within range.

In some embodiments, initiating the first mode may include initiating a wake-up timer associated with the second mode. Each of the wireless devices may be one of a radar module, a wireless local area network (WLAN) module, or a wireless personal area network (WPAN) module. The first mode may be, for example, KLE.

At block 620, in response to identifying a first switch event, the processing logic initiates a second mode. The second mode may be, for example, BSD. In some embodiments, to identify a first switch event, the processing logic determines whether operations associated with the first mode are complete. In response to completing operations associated with the first mode, the processing logic determines whether a wake-up timer associated with the second mode has lapsed. Based on the lapse of the second mode, the processing logic triggers the first switch event. In some embodiments, initiating the second mode may include initiating a wake-up timer associated with the first mode.

At block 630, in response to initiating the second mode, the processing logic periodically selects a wireless device of the plurality of wireless devices to transmit a sensing signal to detect an object. In response to receiving a set of signals derived from the sensing signal by a non-selected wireless device of the plurality of wireless devices, the processing logic obtains, from the non-selected wireless device, a distance to the object. The distance to the object is determined by determining a reception time for each signal of the set of signals, and calculating, for each reflected sensing signal of the set of signals, a difference between the reception time of a respective reflected sensing signal and the reception time of a non-reflected sensing signal of the set of signals. The processing logic converts each difference associated with a reflected sensing signal of the set of signals to the distance.

In some embodiments, the processing logic determines whether operations associated with the second mode are complete. In response to completing operations associated with the second mode, the processing logic determines whether a wake-up timer associated with the first mode has lapsed and triggers the second switch event.

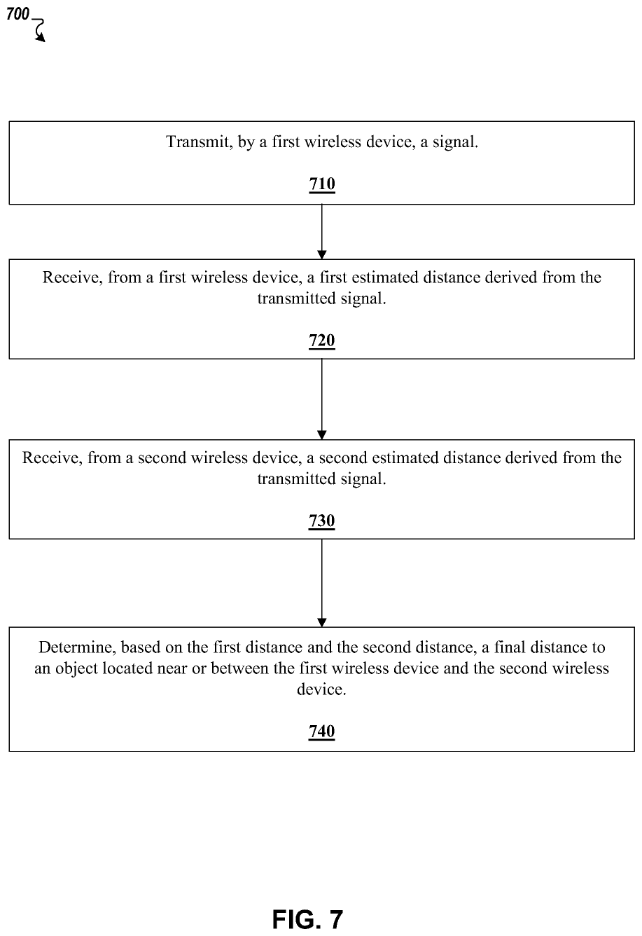

FIG. 7 depicts a flow diagram of an example method 700 for object detection, in accordance with implementations of the present disclosure. Method 700 can be performed by processing logic that can include hardware (circuitry, dedicated logic, etc.), software (e.g., instructions run on a processing device), or a combination thereof. In one implementation, some, or all of the operations of method 700 can be performed by one or more components of system 100 of FIG. 1. In some embodiments, some, or all of the operations of method 700 can be performed by spatial perception logic 116, as described above.

At block 710, the processing logic transmits, by a first wireless device, a signal. The first wireless device or the second wireless device may be one of a radar module, a wireless local area network (WLAN) module, or a wireless personal area network (WPAN) module.

At block 720, the processing logic receives, from a first wireless device, a first estimated distance derived from the transmitted signal. In some embodiments, to receive the first estimated distance, the processing logic switches the first wireless device from transmitting to receiving to receive a reflected signal. A reception time is determined for the reflected signal and converted to the first estimated distance. The reflected signal of the set of signals may refer to a transmitted signal reflected off an object located near or near the first wireless device and the second wireless device that exceeds a predetermined signal threshold.

At block 730, the processing logic receives, from a second wireless device, a second estimated distance derived from the transmitted signal. In some embodiments, to receive the second estimated distance, the processing device receives, by the second wireless device, a set of signals and determines a reception time for each signal of the set of signals. A difference between the reception time of a reflected signal of the set of signals and the reception time of a non-reflected sensing signal of the set of signals is calculated. Each reflected signal corresponds to an object located near the first wireless device and the second wireless device that reflected the transmitted signal. The difference is converted to the second estimated distance. The first wireless device or the second wireless device may be one of a radar module, a wireless local area network (WLAN) module, or a wireless personal area network (WPAN) module.

At block 740, the processing logic determines, based on the first distance and the second distance, a final distance to an object located near or near the first wireless device and the second wireless device.

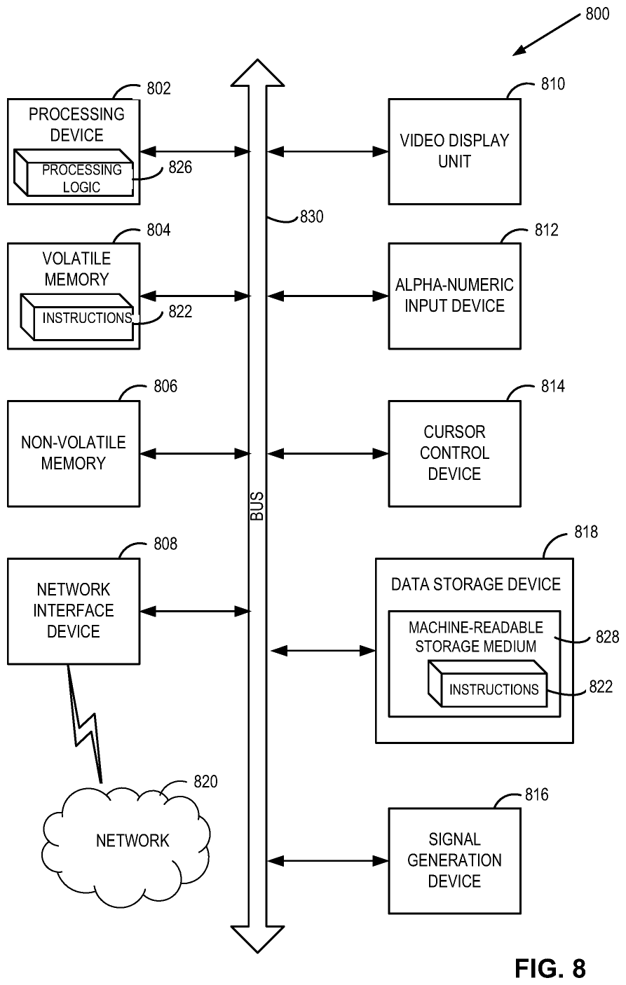

FIG. 8 is a block diagram illustrating an exemplary computer system 800, in accordance with implementations of the present disclosure. The computer system 800 can correspond to microcontroller 110, described with respect to FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 818, which communicate with each other via a bus 850.

Processor (processing device) 802 represents one or more general-purpose processing devices such as a microprocessor, central processing unit, or the like. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application-specific integrated circuit (ASIC), a field programmable gate array (FPGA), a digital signal processor (DSP), a network processor, or the like. The processor 802 is configured to execute instructions 805 (e.g., for providing color recommendations for overlaid text in a video) for performing the operations discussed herein.

The computer system 800 can further include a network interface device 808. The computer system 800 also can include a video display unit 810 (e.g., a liquid crystal display (LCD) or a cathode ray tube (CRT)), an input device 812 (e.g., a keyboard, an alphanumeric keyboard, a motion sensing input device, touch screen), a cursor control device 814 (e.g., a mouse), and a signal generation device 820 (e.g., a speaker).

The data storage device 818 can include a non-transitory machine-readable storage medium 824 (also computer-readable storage medium) on which is stored one or more sets of instructions 805 (e.g., for providing color recommendations for overlaid text in a video) embodying any one or more of the methodologies or functions described herein. The instructions can also reside, completely or at least partially, within the main memory 804 and/or within the processor 802 during execution thereof by the computer system 800, the main memory 804 and the processor 802 also constituting machine-readable storage media. The instructions can further be transmitted or received over a network 830 via the network interface device 808.

In one implementation, the instructions 805 include instructions for color recommendations for overlaid text in a video. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
transmitting, from a first wireless device of a plurality of wireless devices, a sensing signal;
receiving, by a second wireless device of the plurality of wireless devices, a set of signals derived from the sensing signal; and
determining, based on characteristics of the set of signals, a first distance to each object located near the first wireless device and the second wireless device.

2. The method of claim 1, wherein each of the wireless devices is one of: an ultra-wide band (UWB) devices, a radar module, a wireless local area network (WLAN) module, or a wireless personal area network (WPAN) module.

3. The method of claim 1, wherein the set of signals includes a non-reflected sensing signal and one or more reflected sensing signals.

4. The method of claim 3, wherein each reflected sensing signal refers to a sensing signal reflected off an object located near the first wireless device and the second wireless device that exceeds a predetermined signal threshold.

5. The method of claim 1, wherein determining, based on characteristics of the set of signals, the first distance to each object located near the first wireless device and the second wireless device comprises:
determining a reception time for each signal of the set of signals;
calculating, for each reflected sensing signal of the set of signals, a difference between the reception time of a respective reflected sensing signal and the reception time of a non-reflected sensing signal of the set of signals, wherein each reflected sensing signal corresponds to an object located near the first wireless device and the second wireless device that reflected the sensing signal; and
converting each difference associated with a reflected sensing signal of the set of signals to the first distance.

6. The method of claim 1, further comprising:
switching the first wireless device from transmitting to receiving;
receiving, by the first wireless device, a set of reflected sensing signals;
determining, based on characteristics of the set of reflected sensing signals, a second distance to each object located near the first wireless device that reflected the sensing signal; and
obtaining, based on the first distance and the second distance, a final distance for each object located near the first wireless device and near the first wireless device and the second wireless device.

7. An apparatus comprising:
a plurality of wireless devices; and
a processing device coupled to the plurality of wireless devices, wherein the processing device is to perform operations comprising:
in response to initiating a first mode, periodically selecting a wireless device of a plurality of wireless devices to receive a signal from a remote access device;
in response to identifying a first switch event, initiating a second mode; and
in response to initiating the second mode, periodically selecting a wireless device of the plurality of wireless devices to transmit a sensing signal to detect an object.

8. The apparatus of claim 7, wherein the processing device is to perform operations further comprising:
in response to receiving the signal from the remote access device by a selected wireless device of the plurality of wireless devices, transmitting, from the selected wireless device, a signal indicating that the remote access device is within range.

9. The apparatus of claim 7, wherein the processing device is to perform operations further comprising:
in response to receiving a set of signals derived from the sensing signal by a non-selected wireless device of the plurality of wireless devices, obtaining, from the non-selected wireless device, a distance to the object.

10. The apparatus of claim 9, wherein the distance to the object is determined by determining a reception time for each signal of the set of signals, calculating, for each reflected sensing signal of the set of signals, a difference between the reception time of a respective reflected sensing signal and the reception time of a non-reflected sensing signal of the set of signals, and converting each difference associated with a reflected sensing signal of the set of signals to the distance.

11. The apparatus of claim 7, wherein identifying a first switch event comprises:
determining whether operations associated with the first mode are complete;
in response to completing operations associated with the first mode, determining whether a wake-up timer associated with the second mode has lapsed; and
triggering the first switch event.

12. The apparatus of claim 7, wherein initiating the first mode includes initiating a wake-up timer associated with the second mode.

13. The apparatus of claim 7, wherein initiating the second mode includes initiating a wake-up timer associated with the first mode.

14. The apparatus of claim 7, wherein the processing device is to perform operations further comprising:
determining whether operations associated with the second mode are complete;
in response to completing operations associated with the second mode, determining whether a wake-up timer associated with the first mode has lapsed; and
triggering a second switch event.

15. The apparatus of claim 7, wherein each of the wireless devices is one of: an ultra-wide band (UWB) devices, a radar module, a wireless local area network (WLAN) module, or a wireless personal area network (WPAN) module.

16. A processing device comprising:
transmitting, by a first wireless device, a signal;
receiving, from a first wireless device, a first estimated distance derived from the transmitted signal;
receiving, from a second wireless device, a second estimated distance derived from the transmitted signal; and
determining, based on the first estimated distance and the second estimated distance, a final distance to an object located near or near the first wireless device and the second wireless device.

17. The processing device of claim 16, wherein receiving the first estimated distance comprises:
switching the first wireless device from transmitting to receiving;
receiving, by the first wireless device, a reflected signal;
determining a reception time for the reflected signal; and
converting the reception time of the reflected signal to the first estimated distance.

18. The processing device of claim 16, wherein receiving the second estimated distance comprises:
receiving, by the second wireless device, a set of signals;
determining a reception time for each signal of the set of signals;
calculating a difference between the reception time of a reflected signal of the set of signals and the reception time of a non-reflected sensing signal of the set of signals, wherein each reflected signal corresponds to an object located near the first wireless device and the second wireless device that reflected the transmitted signal; and
converting the difference to the second estimated distance.

19. The processing device of claim 16, wherein each of the first wireless device or the second wireless device is one of: an ultra-wide band (UWB) devices, a radar module, a wireless local area network (WLAN) module, or a wireless personal area network (WPAN) module.

20. The processing device of claim 18, wherein the reflected signal of the set of signals refers to a transmitted signal reflected off an object located near or near the first wireless device and the second wireless device that exceeds a predetermined signal threshold.
